(19) United States
(12) Patent Application Publication
(10) Pub. No.: US 2021/0066001 A1
(43) Pub. Date: Mar. 4, 2021

(54) Smart Switch

(71) Applicant: Moshe Landau, Monroe, NY (US)

(72) Inventor: Moshe Landau, Monroe, NY (US)

(21) Appl. No.: 16/559,638

(22) Filed: Sep. 4, 2019

(51) Int. Cl. H01H 9/02; H01H 3/22; H02B 1/46

(52) U.S. Cl. CPC H01H 9/0271; H02B 1/46; H01H 3/227

(57) ABSTRACT

The present invention discloses a universal switch interface includes a monitored switch having an ON mode and an OFF mode of operation visible through a screen display.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates generally to switches for activating various devices and more particularly to multiple switches that operate through a smart screen.

### Description of the Related Art

Under many circumstances, switches that are used to control various devices can be very difficult to operate. For example, people with hand tremors and the like might strike a push-button switch a number of times in a second while intending to simply close or open the switch once. Further, people with handicaps, such as paralysis requiring a switch to be operated by the head, might have difficulty making positive contact every time. Also, toys and other devices for children or sensors used to monitor the disposition of children, patients, etc. might include switches other than push-button switches (e.g. pressure sensors, contact switches, etc.). Other difficulties, such as switch bounce, can occur because of unintentional multiple operations of the switch. Latching, on the other hand, enables a latched period of time for a given input stimulus. When all of these features are combined, the result is a universal switch interface that can accommodate for many difficulties in the industry.

Accordingly, it is an object of the present invention to provide a new and improved smart switch.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention is a device that could take over control of all the switches in the electrical switch box.

Another object of this invention is to provide a device with 4 regular inputs for Hot, Load, Ground and Natural.

An additional object of the invention is to add power supply to a smart screen that will regulate all the switches in the electrical switch box.

It is a further object of the invention to provide a new and improved smart switch that forms a universal switch interface that can accommodate for many difficulties in the industry.

The above objects and others are further realized in a method of monitoring a switch and providing an output from the switch including the steps of providing a digitally displayed switch having an ON mode and an OFF mode of operation for multiple buttons in a traditional switchbox.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows interior view of switch device.

FIG. 2 is another view of the switch device.

FIG. 3 is an overall exterior view of the switch device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

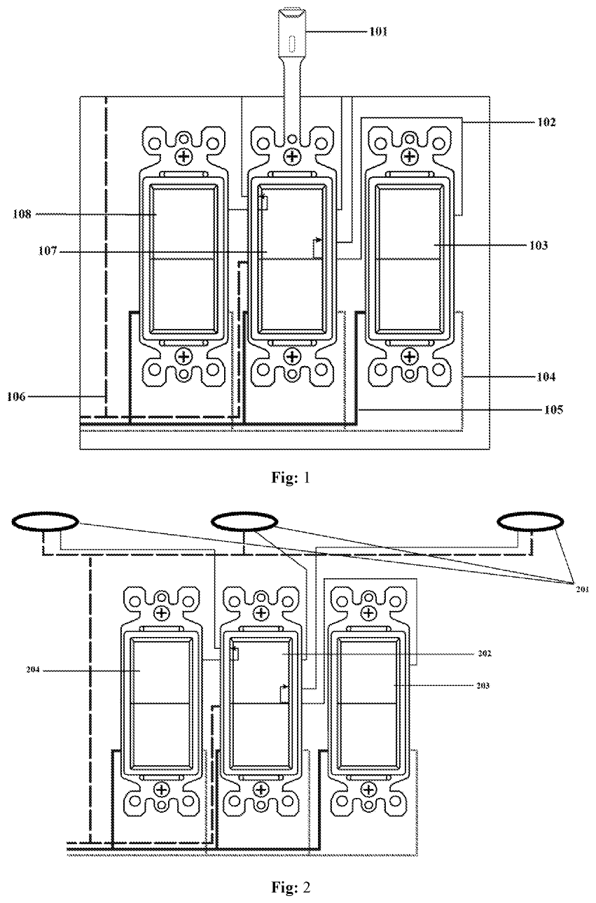

Turning to the drawings, in which like reference characters indicate corresponding elements throughout the several views, attention is first directed to FIG. 1, which graphically illustrates the smart switch interior functionality. On the top there is a link 101 to connect to the out screen through smart switch device 107. There two regular switches on right 102 and left side 108. Then there is 4 regular inputs shown for Hot 105, Load 102, Ground 104 and Natural 106.

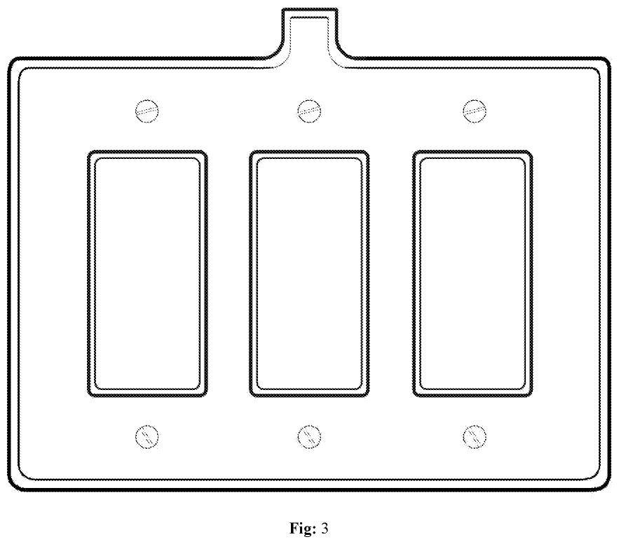

Referring to the diagram of FIG. 2, it shows the light buttons 201. 202 show the smart switch device, 203 and 204 shows the regular switches.

Referring additionally to FIG. 3, it shows the smart switch cover external view.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A smart switch connecting to a power and at least one electronic device, the smart switch comprising:
a) a screen;
b) a smart switch cover;
c) smart switch device.

II: The device will have the four regular inputs for:
a) 1 Hot
b) Load
c) Ground
d) Natural

III: The proposed invention provides power supply to a smart screen to regulate the regular switches.
